(19) United States
(12) Patent Application Publication
(10) Pub. No.: US 2004/0248611 A1
(43) Pub. Date: Dec. 9, 2004

(54) Opening and closing device

(76) Inventors: Katsuichi Minami, Obama-shi (JP); Yoshiharu Abe, Katano-shi (JP)

Correspondence Address: RATNERPRESTIA, P O BOX 980, VALLEY FORGE, PA, 19482-0980, US

(21) Appl. No.: 10/827,702

(22) Filed: Apr. 20, 2004

(30) Foreign Application Priority Data
May 21, 2003 (JP) 2003-143008

(51) Int. Cl. H04M 1/00

(52) U.S. Cl. 455/550.1; 455/575.3

(57) ABSTRACT

An opening and closing device is structured so that a first spring and a second spring having different outer diameters are provided. The first spring having a larger outer diameter surrounds the second spring having a smaller diameter, and these springs urge a rotor. This structure can provide an opening and closing device that has a large operating load even within limited dimensions and shapes of the springs and a proper feel of operating and closing operation, and is more positively held in operating and closing positions.

### TECHNICAL FIELD

The present invention relates to an opening and closing device for use in various kinds of electronic equipment, e.g. a portable telephone and small personal computer.

### BACKGROUND OF THE INVENTION

As various kinds of electronic equipment, e.g. a portable telephone and small personal computer, has had more advanced or diversified functions in recent years, there is an increasing number of folding type electronic equipment in which a movable housing is attached to a fix housing of the equipment so that the movable housing can be opened and closed with respect to the fix housing. Accordingly, an opening and closing device for use in this type of electronic equipment, as disclosed in Japanese Patent Unexamined Publication No. 2002-89542, also requires that opening and closing operation should have a proper feel and the opening and closing positions should positively be held.

However, in the structure disclosed in Japanese Patent Unexamined Publication No. 2002-89542, when the opening and closing states are held more positively, a nimble feel of opening and closing operation tends to deteriorate. For this reason, an opening and closing device that can satisfy nimble opening and closing operation and positive opening and closing states at the same time is requested.

### SUMMARY OF THE INVENTION

An opening and closing device of the present invention is structured to have a plurality of coil springs having different outer diameters so that a spring having a smaller diameter is placed inside of a spring having a larger diameter and the plurality of springs urge a rotor or a stator. This structure can provide an opening and closing device that has a large operating load within limited dimensions and shapes and a proper feel of opening and closing operation and is positively held in opening and closing positions.

### BRIEF DESCRIPTION OF THE DRAWINGS

FIG. 1 is a sectional view of an opening and closing device in accordance with an exemplary embodiment of the present invention.

FIG. 2 is an exploded perspective view of the opening and closing device in accordance with the exemplary embodiment of the present invention.

FIG. 3 is a perspective view of an electronic equipment incorporating the opening and closing device in accordance with the exemplary embodiment of the present invention.

FIG. 4 is a sectional view of an opening and closing device in accordance with a comparative example.

FIG. 5 is an exploded perspective view of the opening and closing device in accordance with the comparative example.

### DETAILED DESCRIPTION OF THE INVENTION

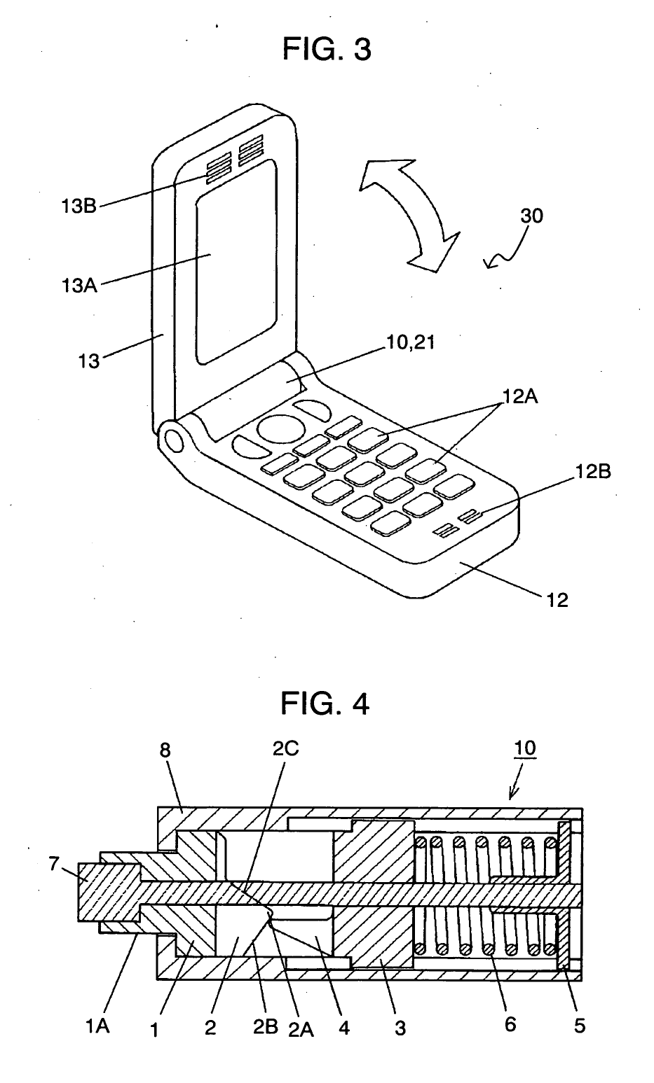

First, a comparative example is described with reference to FIGS. 3 to 5. In the sectional view of these drawings, the radial direction is enlarged to facilitate understanding of the relation between a stator cam and a rotor cam.

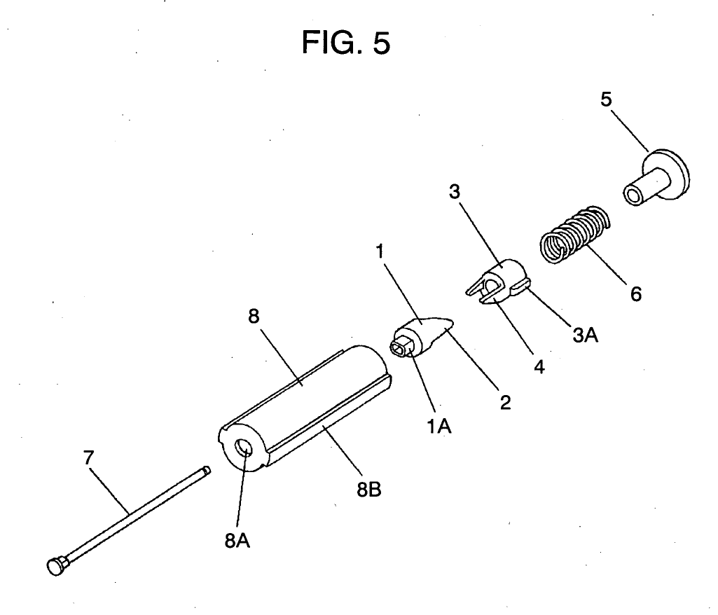

As shown in FIGS. 4 and 5, substantially cylindrical stator 1 has fixed part 1A on the left side face and stator cams 2 along the outer periphery of the right side face thereof. Each stator cam 2 is formed of projecting tip portion 2A and two tilting portions 2B and 2C extending laterally from projecting tip portion 2A.

Substantially cylindrical rotor 3 disposed rotatably in opening and closing directions with respect to stator 1 has rotor cams 4 along the outer periphery of the left side face thereof, i.e. the face opposed to stator cams 2. Between substantially disk-shaped cover 5 and stator 3, coil spring 6 is installed in a little contracted state. In the case of FIG. 4, spring 6 brings the tips of rotor cams 4 into resilient contact with tilting portions 2B of stator cams 2.

Stator 1 is fixed to the left end of substantially columnar fix shaft 7. The right end of the fix shaft 7 is engaged with cover 5, with the fix shaft 7 passing through a hollow part of rotor 3 and spring 6.

From hole 8A at the left end of substantially tubular rotary case 8, fixed part 1A of stator 1 rotatably projects. Into grooves 8B along the inner periphery of rotary case 8, protrusions 3A on rotor 3 are inserted. Thus, rotor 3 is accommodated in rotary case 8 to be movable in the axial direction.

Cover 5 covers an opening at the right end of rotary case 8 with rotor 1, stator 3, spring 6 and other components accommodated in rotary case 8. Thus, opening and closing device 10 is completed.

An example of so structured opening and closing device 10 for use in portable telephone 30 is shown in FIG. 3. Fixed part 1A is fixed to fix housing 12 that has operating part 12A made of a plurality of keys, and sound input part 12B, e.g. a microphone, formed on the top face thereof. On the other hand, rotary case 8 is fixed to movable housing 13 that has display 13A, e.g. liquid crystal display (LCD), and sound output part 13B, e.g. a speaker, formed on the surface thereof. Thus completed is portable telephone 30 in which opening and closing device 10 journals movable housing 13 so that the movable housing 13 can be opened and closed with respect to fix housing 12.

In this opening and closing device 10, while the tip of each rotor cam 4 is in resilient contact with tilting portion 2B on the lower side of each stator cam 2 as shown in FIG. 4, rotor 3 is urged in a closing direction corresponding to the downward direction in the drawing by spring 6. As a result, movable housing 13 fixed to rotary case 8 is held in a closed state with respect to fix housing 12.

When movable housing 13 is opened by hands in this closed state, rotor 3 rotates engaged with rotary case 8 fixed to movable housing 13 to further contract spring 6. Then, the tip of rotor cam 4 moves from tilting portion 2B of stator cam 2 through projecting tip portion 2A, slides upwardly, and comes into resilient contact with upper tilting portion 2C. Thus, rotor 3 is urged to an opening direction corresponding to the upward direction in the drawing, so that movable housing 13 is held open.

In other words, the opening or closing operation of movable housing 13 with respect to fix housing 12 is performed by rotating rotary case 8 fixed to movable housing 13, then the tip of each rotary cam 4 comes into resilient contact with tilting portion 2B or 2C of corresponding stator cam 2 by spring 6 which urges rotor 3 in the opening or closing direction. With this structure, the opening and closing device of the comparative example can provide a proper feel of opening and closing operation and is positively held in opening and closing positions at the same time.

In the case of the opening and closing device of the comparative example, however, to increase the load at opening or closing operation, it is only the way to increase the load of the spring in use within a limited dimension. and shape and within a range not exceeding the allowable stress of the spring. For this reason, it is difficult to increase the operating load in order to hold opening and closing positions more positively with keeping a nimble feel of opening and closing operation.

The present invention addresses these problems of prior arts and the comparative example. Therefore, the present invention can provide an opening and closing device that has a large operating load and a proper feel of opening and closing operation, and is more positively held in opening and closing positions.

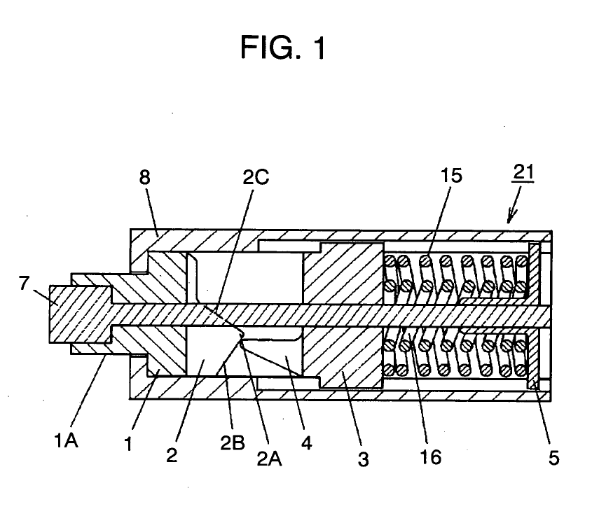

Next, an exemplary embodiment of the present invention is described with reference to FIGS. 1 to 3. Elements similar to those of the comparative example are denoted with the same reference marks and detailed description of those elements is omitted. In the sectional view of these drawings, the radial direction is enlarged to facilitate understanding of the relation between a stator cam and rotor cam.

### EXAMPLARY EMBODIMENT

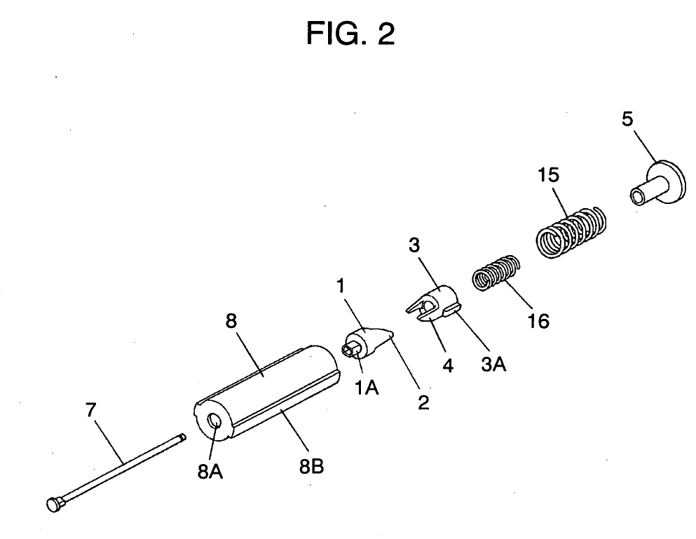

A description is provided of a structure of an opening and closing device of an exemplary embodiment of the present invention with reference to FIGS. 1 and 2. Metallic stator 1 has substantially a cylindrical shape with fixed part 1A formed on the left side face thereof. Stator 1 also has stator cams 2 along the right outer periphery thereof. Each stator cam 2 has projecting tip portion 2A and two tilting portions 2B and 2C laterally extending from this projecting tip portion 2A.

Substantially cylindrical metal rotor 3 is disposed rotatably in opening and closing directions with respect to stator 1. Along the left outer periphery of rotor 3, i.e. the face opposed to stator cams 2, rotary cams 4 are provided. Now, the opening and closing directions refer to either of a clockwise direction or a counter-clockwise direction around fix axis 7.

Further, on the right side of rotor 3, coil first spring 15 and second spring 16 made of metal wires are provided. First spring 15 is wound counter-clockwise. Second spring 16 having a smaller outer diameter than first spring 15 is wound clockwise, a direction opposite to that of first spring 15. Second spring 16 having a smaller outer diameter is disposed inside of first spring 15 having a larger outer diameter. First spring 15 and second spring 16 are installed between the right side face of rotor 3 and substantially disk-shaped cover 5 in a little contracted state. These springs bring the tips of rotor cams 4 into resilient contact with tilting portions 2B of stator cams 2.

Stator 1 is fixed to the left end of substantially columnar fix shaft 7. The right end of the fix shaft 7 is engaged with cover 5, with the fix shaft 7 passing through the hollow part of rotor 3, first spring 15, and second spring 16.

Further, fixed part 1A of stator 1 rotatably projects from hole 8A at the left end of substantially tubular rotary case 8. Grooves 8B along the inner periphery of rotary case 8 are formed to project from the outer periphery of rotary case 8. Protrusions 3A on rotor 3 are inserted into grooves 8B. Thus, rotor 3 is accommodated into rotary case 8 to be movable in the axial direction of fix shaft 7.

Cover 5 covers an opening at the right end of rotary case 8, with stator 1, rotor 3, first spring 15, second spring 16, and other components accommodated in rotary case 8. Thus, opening and closing device 21 is structured.

An example of so structured opening and closing device 21 for use in portable telephone 30 is shown in FIG. 3. Fixed part 1A of opening and closing device 21 is fixed to fix housing 12 that has operating part 12A made of a plurality of keys, and sound input part 12B, e.g. a microphone, formed on the top face thereof. On the other hand, rotary case 8 is fixed to movable housing 13 that has display 13A, e.g. LCD, and sound output part 13B, e.g. a speaker, formed on the surface thereof. Thus produced is portable telephone 30 in which opening and closing device 21 journals movable housing 13 so that the movable housing can be opened and closed with respect to fix housing 12.

Next, a description is provided of the operation of the opening and closing device of this embodiment.

While the tip of each rotor cam 4 is in resilient contact with lower tilting portion 2B of corresponding stator cam 2 as shown in FIG. 1, rotor 3 is urged in a closing direction corresponding to the downward direction by first spring 15 and second spring 16. As a result, movable housing 13 fixed to rotary case 8 is held in a closing state with respect to fix housing 12.

When movable housing 13 is opened by hands in this closing state, rotor 3 rotates in the upward direction in FIG. 1 engaged with rotary case 8 fixed to movable housing 13. The tip of rotor cam 4 moves to upper tilting portion 2C through projecting portion 2A of stator cam 2 in resilient contact therewith. In this state, rotor 3 is urged in an opening direction corresponding to the upper direction in the drawing, so that movable housing 13 is held open.

In other words, the opening or closing operation of movable housing 13 rotates rotary case 8 and brings the tips of rotary cams into resilient contact with tilting portions 2B or 2C of stator cams 2. As a result, rotor 3 is urged in the closing or opening direction by first spring 15 and second spring 16. Thus, the opening or closing operation of movable housing 13 with respect to fix housing 12 is performed.

At this time, rotor 3 is urged by both of first spring 15 and second spring 16. Even through each spring is within a limited dimension and shape and has a load within a range not exceeding the allowable stress of the spring, the loads of two springs add to and urge rotor 3, thereby bringing rotor cams 4 into resilient contact with stator cams 2 with a larger force. This can improve a feel of opening and closing operation and more positively hold the device in the opening and closing positions.

Further, first spring 15 and second spring 16 may have different wire diameters, or different numbers of turns, in addition to different outer diameters. The two springs may also have different values of load when they are contracted by a predetermined amount, i.e. so-called spring constants. Combination of springs having different spring constants can realize an opening and closing device that can provide a desired operating load at a predetermined opening angle.

As described above, in this embodiment, opening and closing device 21 is structured so that first coil spring 15 and second coil spring 16 having different outer diameters are provided, second spring 16 having a smaller outer diameter is disposed inside of first spring 15 having a larger outer diameter, and these springs urge rotor 3. This structure can provide an opening and closing device that has a large operating load even within limited dimensions and shapes of the springs and a proper feel of opening and closing operation, and is more positively held in opening and closing positions.

Moreover, winding first spring 15 and second spring 16 in opposite directions from each other can prevent entanglement of the springs at assembling or opening and closing operation, and stabilize the operation of the opening and closing device.

Next, a description is provided of another exemplary embodiment of the present invention. In another embodiment, first spring 15 and second spring 12 are installed between the left side face of stator 1 and the inner wall of the left face of rotary case 8. With this structure, the two springs urge stator 1 and bring stator cams 2 into resilient contact with rotor cams 4. This structure can also provide an opening and closing device that has an improved feel of opening and closing operation and is more positively held in opening and closing positions, and thus attain the object of the present invention.

In this embodiment, description is provided of a structure using two springs, i.e. second spring 16 having a smaller outer diameter disposed inside of first spring 15 having a larger outer diameter. However, when the opening and closing device is rather large, three or more springs having different spring constants can be used to provide various operating loads at predetermined opening angles. For example, a first spring can surround a second spring and the second spring can further surround a third spring.

In the above description, rotary case 8 fixed to movable housing 13 is rotated by opening and closing the movable housing with hands. The present invention can also be implemented by a so-called one-push open structure, in addition to opening and closing operation by hands. For this structure, other components, e.g. a push button and reverse-cam for reversing the position in which rotor cams 4 are in resilient contact with stator cams 2, are provided and movable housing 13 is opened by depressing the push button in the closing state.

As described above, the present invention provides the following advantage: realizing an opening and closing device that has a large operating load and a proper feel of opening and closing operation and is more positively held in opening and closing positions, without change in the shape or increase in the size of the device.

1. An opening and closing device comprising:
a stator having a stator cam;
a rotor having a rotor cam in contact with the stator cam, and held to be rotatable with respect to the stator; and
a plurality of coil springs urging at least one of the stator and the rotor;
wherein a first coil spring of the plurality of coil springs surrounds second coil spring of the plurality coil springs.

2. The opening and closing device of claim 1, wherein
an inner diameter of the first coil spring is larger than an outer diameter of the second coil spring.

3. The opening and closing device of claim 2, wherein the first coil spring and the second coil spring are wound in opposite directions from each other.

4. The opening and closing device of claim 1, wherein the plurality of coil springs urge one of the stator and the rotor at the same time.

5. The opening and closing device of claim 1, wherein
the rotor is held to be slidable in the case; and
the plurality of springs urge the rotor at the same time to force the rotor cam onto the stator cam.
